(19) United States
(12) Patent Application Publication
(10) Pub. No.: US 2015/0379564 A1
(43) Pub. Date: Dec. 31, 2015

(54) REDUCING OVER-DELIVERY OF SPONSORED CONTENT

(71) Applicant: LinkedIn Corporation, Mountain View, CA (US)

(72) Inventor: Yingfeng Oh, Mountain View, CA (US)

(21) Appl. No.: 14/318,341

(22) Filed: Jun. 27, 2014

(51) Int. Cl. G06Q 30/02

(52) U.S. Cl. CPC G06Q 30/0249; G06Q 30/0273; G06Q 30/0277

(57) ABSTRACT

A system, apparatus, and method are provided for reducing, stemming, or eliminating over-delivery of sponsored content, such as advertisements. Upon receipt at a tracking server of a notification of an event related to serving or presentation of a content item, or user interaction with an item, it is quickly determined whether the event is of a particular type (e.g., a revenue event). If so, it is quickly forwarded to a different server or processing module for rapid processing in order to determine whether any budget associated with a sponsored content item corresponding to the event has been depleted. All revenue events may be prioritized equally, or some revenue events may be prioritized over others.

### BACKGROUND

This disclosure relates to the field of computer systems. More particularly, a system and methods are provided for reducing or preventing over-delivery of sponsored content such as advertisements.

Some content-serving systems earn revenue by charging content providers to deliver their content to users of the systems. For example, advertisers pay web site operators and other publishers to serve their advertisements (or other sponsored content) based on a cost-per-click (CPC), a cost-per-mille (CPM), a cost-per-action (CPA), or some other basis.

Typically, an advertiser sets a budget limiting the amount of money the advertiser is willing to pay for its advertisements during a given day or other recurring time period, and/or over a longer time spanning multiple recurring time periods. Content publishers then charge for serving the advertisements and/or obtaining desired actions (e.g., clicks), and track depletion of the advertisers' budgets. The publishers ensure that the advertisers receive the service they paid for, based on numbers of clicks, impressions, actions, or other metrics, but desire to stop serving a given advertiser's content as soon as the corresponding budget is depleted. Based on their agreement, the publisher may be unable to charge the advertiser for any excess services provided or results obtained beyond the budgeted amount.

However, popular content-serving systems and sites serve large numbers of ad impressions and other sponsored content, and must process enormous numbers of events related to these actions. For example, a content publisher's system may receive notifications every time a content item is served, whether sponsored or not, and every time a user to whom a content item is served interacts with the item in some way (e.g., clicks on it, refreshes it). To process the events, a content publisher will normally buffer or batch events over some time period (e.g., 30 seconds, 3 minutes) and then process all events that have been accumulated; some systems perform two or more batching phases. These time delays, and the time needed to process the thousands, millions, or billions of batched events, means that some sponsored content items may continue to be served for significant periods of time after their budgets have actually been depleted.

In particular, a given budget may be depleted several minutes or more before the publisher's system can verify this fact and take action to ensure that the corresponding content is no longer served during a time period associated with the depleted budget.

### DESCRIPTION OF THE FIGURES

FIG. 1 is a block diagram depicting a computing environment in which over-delivery of sponsored content is reduced or prevented, in accordance with some embodiments.

FIG. 2 is a flow chart illustrating a method of reducing or preventing over-delivery of sponsored content, in accordance with some embodiments.

FIG. 3 depicts event-tracking as applied to reduce or prevent over-delivery, in accordance with some embodiments.

FIG. 4 depicts an apparatus for reducing or preventing over-delivery of sponsored content, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the invention or inventions associated with this disclosure are not intended to be limited to the embodiments shown, but rather are to be accorded the widest scope consistent with the disclosure.

In some embodiments, a system, apparatus, and methods are provided for reducing, limiting, or preventing over-delivery of sponsored content. In these embodiments, over-delivery of sponsored content refers to delivery of content beyond what is covered by an associated budget. A budget associated with some particular content (e.g., an individual content item) may be for a recurring time period (e.g., an hour, a day, a week) or for a single time period that may encompass multiple recurring time periods—such as an overall budget for an advertisement, an advertisement campaign, or an account that encompasses one or more advertisements and/or campaigns.

Although some implementations of these embodiments are described as they may be implemented regarding over-delivery of paid advertisements, they may be readily modified to reduce or prevent over-delivery of other sponsored or unsponsored content (e.g., notifications of job openings, audio and/or video entertainment), as will be apparent to one of ordinary skill in the art. Thus, “sponsored content” is intended to encompass any type of content for which a provider of the content is willing to pay a publisher to serve the content to users of an application or service provided by the publisher, or any other type of content for which associated events are deemed worthy of prioritized handling.

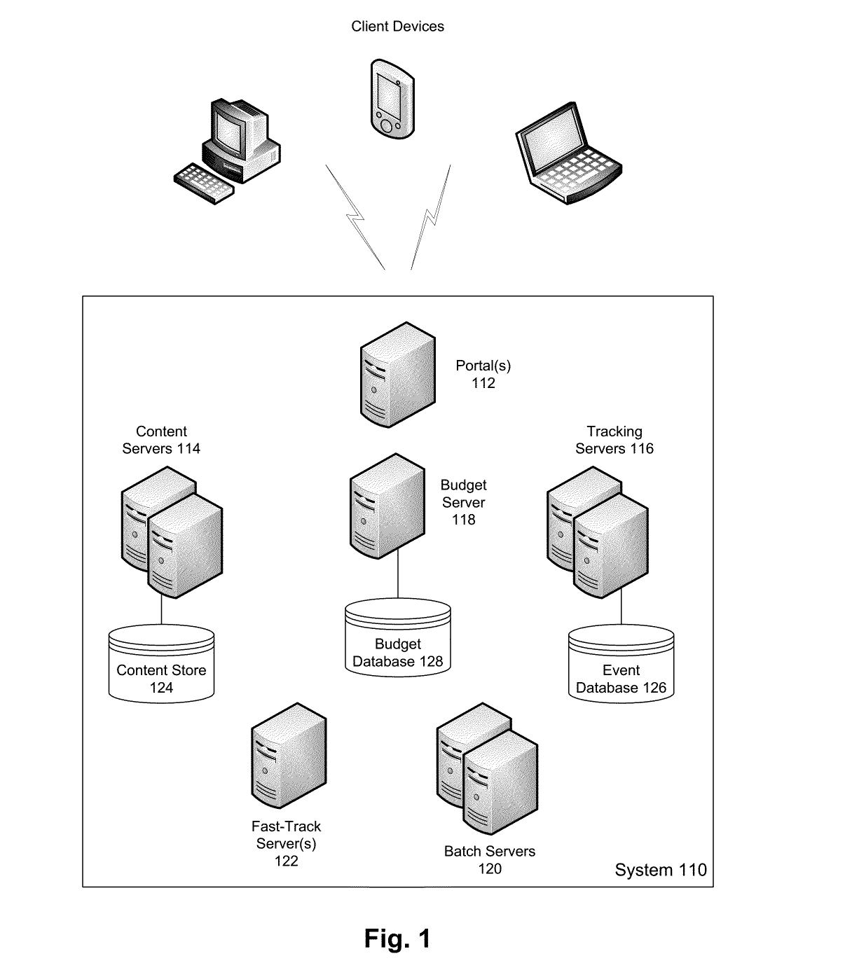

FIG. 1 is a block diagram depicting a computing environment in which over-delivery of sponsored content is reduced or prevented, according to some embodiments.

In these embodiments, system 110 is (or is part of) a data center or other collection of computer resources that hosts a professional or social networking service that helps members create, develop, and maintain professional (and personal) relationships, as provided by LinkedIn® Corporation for example. In other embodiments, system 110 may support or host an application, service, or web site that publishes some other type or types of content.

Users of a service or services hosted by system 110 connect to the system via client devices, which may be stationary (e.g., desktop computer, workstation) or mobile (e.g., smartphone, tablet computer, laptop computer). The client devices operate suitable client applications, such as a browser program or an application designed specifically to access a service offered by system 110, in order to display content served to them by the system.

Content served by system 110 includes sponsored content, which earns revenue for the system (or an operator of the system), and unsponsored content. Individual content items that are served may include status updates, messages, advertisements, offers, announcements, job listings, news, informative articles, activities of other users, and so on, and may be or may include any type of media (e.g., text, graphics, image, video, audio). Content items published or served by system 110 may include content generated by users of the system's services and/or content supplied by third parties for delivery to users of those services. Thus, a sponsor for a given item of sponsored content may be a member of the system's service or a third party (i.e., an entity that is not a member of the service).

Users of system 110 may be termed members because they may be required to register with the system in order to fully access the available service or services. Members may be identified and differentiated by username, electronic mail address, telephone number, and/or some other unique identifier.

Interactive user/member sessions are generally made through portal(s) 112, which may comprise an application server, a web server, and/or some other gateway or entry point. The portal through which a given session is established may depend on the person's device or method of connection. For example, a user of a mobile client device may connect to system 110 via a different portal (or set of portals) than a user of a desktop or workstation computer.

System 110 also includes content servers 114, tracking servers 116, budget server 118, batch servers 120, fast-track server(s) 122, content store 124, event database 126, and budget database 128.

Content servers 114 maintain one or more repositories of content items for serving to members (e.g., content store 124), an index of the content items, and/or other information useful in serving content to members. Illustratively, content server 114 may serve on the order of hundreds of millions of items every day. As indicated above, a content store may include various types of sponsored and/or unsponsored content items for serving to members and/or for use by various components of system 110, which may be generated within the system or by external entities. Content servers 114 (or some other component of system 110) may include a recommendation module for recommending content to serve to a member.

Tracking servers 116 monitor and record (e.g., in event database(s) 126) activity of system 110 and/or members. For example, whenever content is served from the system (e.g., to a client device), the tracking server is informed of what is served, to whom (e.g., which member), when it was served, and/or other information. Similarly, the tracking server also receives notifications of member actions regarding content actions, to include identities of the member and the content acted upon, the action that was taken, when the action was taken, etc. Illustrative actions that may be captured include, but are not limited to, clicks/taps/pinches (on the content, on a logo or image), conversions, follow-on requests, visiting a page associated with a subject or provider of the content, taking some other action regarding the content (e.g., commenting on it, sharing it, following its provider, liking it), and so on.

Thus, for each of multiple significant types of actions, an “event” is fired and delivered to a tracking server. Some events are received from system components while others are received from client devices and/or other devices external to system 110. For example, when a content server serves an advertisement (or “ad”) impression that earns revenue on a CPM (cost-per-mille) basis, a corresponding event is received from that content server. As another example, when an ad impression that earns revenue on a CPC (cost-per-click) or CPA (cost-per-action) basis is displayed on a client device, a corresponding event is received from that device via a client-side counting mechanism. If a user clicks on or otherwise interacts with a CPC ad or CPA ad, yet another event is received.

In some implementations, some events may be processed by other components of system 110 (e.g., fast-track server 122, a batch server 120, another type of server for handling priority events), in addition to or instead of a tracking server 116 in which case those other components may record some or all of the relevant data in event database 126 or some other repository.

In embodiments described herein, tracking servers 116 receive massive numbers of events. In some illustrative scenarios, the number of events received at the tracking servers may exceed one billion in a single day. For each event that corresponds to a sponsored content item, the system must determine quickly whether any budget associated with the item has been depleted, so that the item will not be served any more during a time period associated with the depleted budget.

Budget server 118 maintains budgets of sponsored content in budget database 128. A given content sponsor may establish budgets for individual content items, for a campaign comprising one or more items, and/or for the sponsor's entire account, which may encompass any number of campaigns and/or items. Further, within a given tier (e.g., item, campaign, account), a sponsor may establish recurring budgets for recurring time periods (e.g., hour, day, week) and/or overall budgets.

As an example, one advertiser having one account that includes two campaigns and multiple advertisements (e.g., impressions, creatives) in each campaign may establish daily budgets for each impression/creative, as well as overall budgets for each campaign. System 110 will then strive to stop serving each impression/creative as soon as its daily budget is met or depleted, and also as soon as its overall campaign budget is met or exhausted. Thus, the system must not only track daily (or other periodic) activity of the sponsor's advertisements and monitor depletion of associated budgets, but also track depletion of the overall budgets.

In some embodiments, in order to stop serving a given sponsored content item quickly upon depletion of an associated budget, the tracking servers are configured to prioritize handling or processing of some events over other events. For example, upon receipt of a new event, a given tracking server may immediately identify a type of the event. If the event is of a prioritized type, it may be immediately forwarded to a fast-track server 122 for further processing. Non-prioritized events are buffered, batched, aggregated, coalesced, or otherwise collected and dispatched to one or more batch servers 120.

In some implementations, instead of forwarding a prioritized event to fast-track server 122 or some other component, a tracking server may generate a copy or duplicate of the event and send the copy (or the original) to the fast-track server and retain the original (or the copy) for normal processing. In these implementations, the fast-track server or other component processes events (or copies of events) solely or primarily for the purpose of updating and maintaining budgets associated with the events' corresponding content, while the tracking server processes the events for other purposes—such as counting total numbers of impressions served, tracking the performance of the content, accumulating statistics regarding reach or exposure, etc.

Thus, prioritized events are immediately identified and handled specially in order to update their budgets or, more accurately, update the status of (e.g., depletion of) their budgets, and determine whether the system should stop serving the associated content for the current time period and/or overall. Handling of events, including prioritized and non-prioritized events is further described below.

System 110 may include other components not illustrated in FIG. 1. For example, in some embodiments system 110 includes a profile server to maintain profiles, in a profile database, of members of the service(s) hosted by system 110. An individual member's profile may reflect any number of attributes or characteristics of the member, including personal (e.g., gender, age or age range, interests, hobbies, member ID), professional (e.g., employment status, job title, functional area or industry, employer, skills, endorsements, professional awards), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify who sent a message, to identify a recipient of a status update, to select content to serve to the member or an associated member, to record a content-delivery event).

Organizations may also be members of the service (i.e., in addition to individuals), and may have associated descriptions or profiles comprising attributes such as industry (e.g., information technology, manufacturing, finance), size, location, goal, etc. An “organization” may be a company, a corporation, a partnership, a firm, a government agency or entity, a not-for-profit entity, an online community (e.g., a user group), or some other entity formed for virtually any purpose (e.g., professional, social, educational).

In some embodiments, system 110 includes a connection server that stores data representing members' associations/connections/relationships. Illustratively, the members' associations may be stored as a graph in which each node corresponds to one member or user, and each edge between two nodes corresponds to a relationship between the members/users represented by the two nodes. The network of members of a service offered by system 110 may number in the tens or hundreds of millions, and so the graph of members' associations may be distributed across multiple databases or repositories, instead of a single connection store.

A profile server may be combined with a connection server, in which case a combined profile/connection server maintains members' profiles and also stores members' associations with each other. Alternatively, a connection server may be distinct from a profile server, but there may be overlap between the information stored on the connection server and on the profile servers.

Members of a service hosted by system 110 have corresponding pages (e.g., web pages, content pages) on the system, which they may use to facilitate their activities with the system and with each other, to form connections/relationships with other members, inform friends and/or colleagues of developments in their lives/careers, etc. These pages (or information provided to members via these pages) are available to some or all other members. Members' pages may be stored on a component of system 110 depicted in FIG. 1, or on a component not shown in the figure.

Functionality of system 110 may be distributed among its components in an alternative manner, such as by merging or further dividing functions of one or more components, or may be distributed among a different collection of components. Yet further, while depicted as separate and individual hardware components (e.g., computer servers) in FIG. 1, one or more of portal 112, content servers 114, tracking servers 116, budget server 118, batch servers 120, and fast-track server(s) 122 may alternatively be implemented as separate software modules executing on one or more computer servers. Thus, although only a single instance of a particular component of system 110 may be illustrated in FIG. 1, it should be understood that multiple instances of some or all components may be utilized.

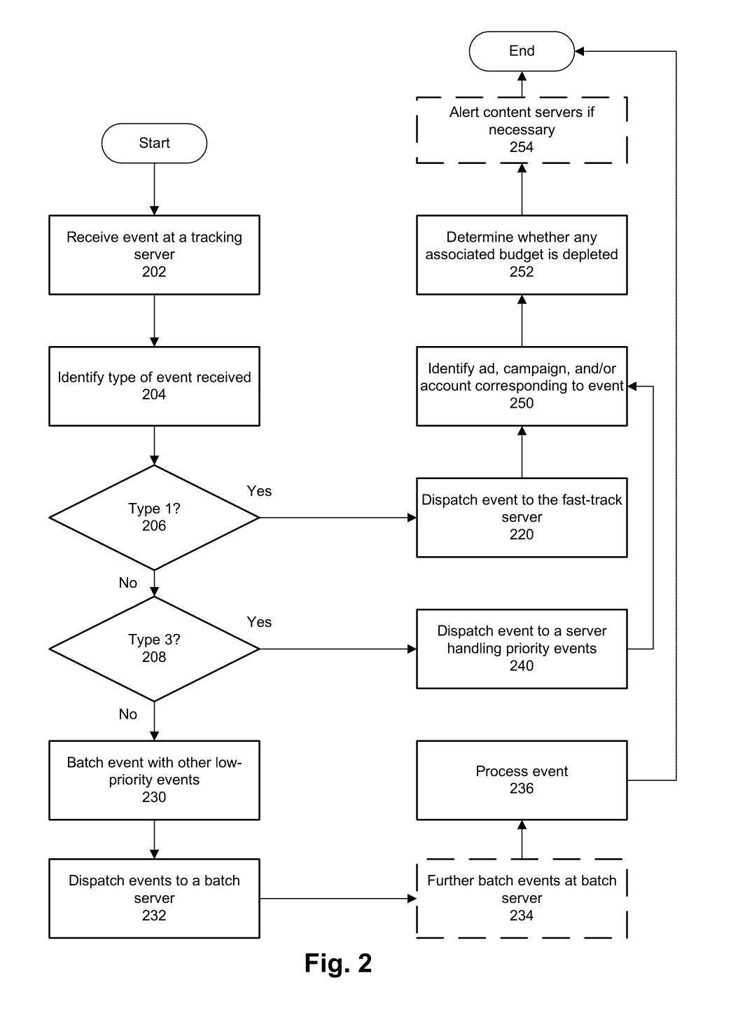

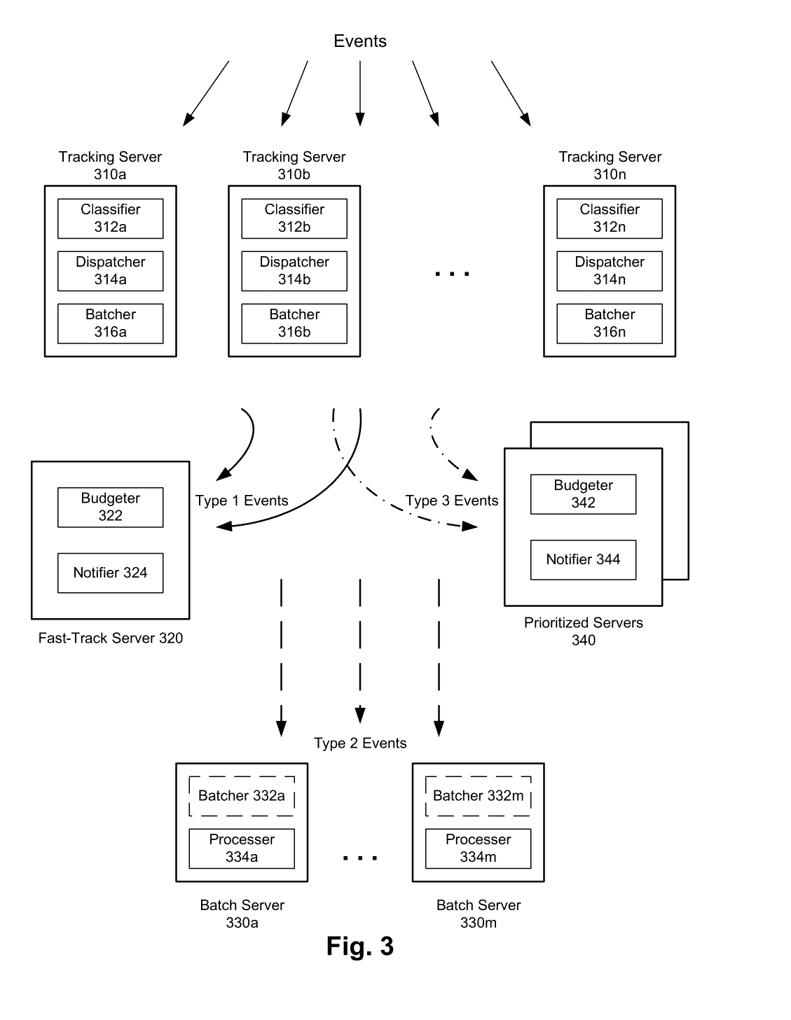

FIG. 2 is a flow chart illustrating a method of reducing, stemming, or preventing over-delivery of sponsored content, while FIG. 3 depicts event-tracking as applied to reduce, stem, or prevent over-delivery, according to some embodiments. The method of FIG. 2 will be described with reference to FIG. 3. Although the method is described as implemented to reduce or stem over-delivery of paid advertisements, over-delivery of some other type of sponsored content may be addressed in a similar manner.

In these embodiments, different types of events related to sponsors' advertisements are handled or processed with different priorities. As a consequence, the statuses (e.g., levels of depletion) of some budgets will be updated or determined faster than statuses of other budgets, thereby allowing some content to be “turned off” (i.e., prevented from being further served) faster.

In operation 202, a new event is received at a tracking server within a system that serves advertisements as well as unsponsored content (e.g. tracking server 310b of FIG. 3). The event may be received from another component of the system, from a client device that a user employs to view the content, or from some other source.

In operation 204, the tracking server identifies a type of the event. This may be done by classifier 312b of tracking server 310b, which may be a program module comprising processor-executable program code. In some embodiments, each event's type is identified in the data that conveys it. For example, when an ad is served or sent from the system toward a user, an event may be generated with a form similar to ‘type=impression(server-side).’ When an ad is rendered on a client device, an event of the form ‘type=impression(client-side)’ may be generated, when a user likes a content item the corresponding event may be represented as ‘type=like’, and so on.

In the illustrated embodiments, three types of events are defined, although fewer or more types may be defined in other embodiments. A first type of event (i.e., a type-1 event) corresponds to user interaction with an advertisement (e.g., a creative, an impression) that generates revenue on a CPC or CPA basis. For example, the event may have been fired when a user clicked on a CPC ad, completed a form associated with a CPA ad, etc. Events of the first type are thus high-priority events that generate revenue for the system (or an operator of the system).

A second type of event (i.e., a type-2 event) corresponds to action or interaction that generates no revenue. Examples of these low-priority events are serving a CPC ad, serving a CPA ad, serving or displaying unsponsored content, and user interaction with unsponsored content.

A third type of event (i.e., a type-3 event) is a priority event that is lower in priority than events of the first type, but which also generates revenue. For example, serving a CPM ad could be an event of the third type. In embodiments in which only two types of events are defined, type-3 events may instead be considered type-1 or type-2 events.

As shown in FIG. 3, in the illustrated method type-1 events are routed to fast-track server 320, which processes just the highest-priority events, while type-2 events are routed to batch servers 330 and type-3 events are routed to other servers 340. In the content-serving system of FIG. 3, forwarding or dispatching an event from a tracking server according to its priority is handled by dispatcher modules 314 (e.g., dispatcher 314b of tracking server 310b).

In operation 206, the tracking server determines whether the event is a type-1 event. If so, the method advances to operation 220 where the event or a copy of the event is immediately forwarded to a specialized computer (e.g., fast-track server 320 of FIG. 3), and then to operation 250; otherwise the method continues at operation 208.

In operation 208, the system determines whether the event is a type-3 event. If so, the method advances to operation 240 where the event or a copy of the event is forwarded to one of a set of servers handling prioritized (but not the highest-priority) events, and then to operation 250; otherwise the method continues at operation 230.

In operation 230, the event is a type-2 event (or some other low-priority event, if there are more than three types), and so the tracking server buffers the event in order to batch it or aggregate it with other events. After some period of time (e.g., 30 seconds, 2 minutes), in operation 232 the tracking server dispatches the collected low-priority events to a batch server (e.g., batch server 330a of FIG. 3) for further processing. In the system of FIG. 3, aggregation of low-priority events within tracking servers is performed by batcher modules 316 (e.g., batcher 316b of tracking server 310b).

In embodiments in which just copies of type-1 and type-3 events are dispatched for priority handling, the original events are accumulated, batched, and processed just like low-priority type-2 events. As described above, for example, the prioritized copies of events allow rapid processing of corresponding events for some purposes (e.g., updating budget statuses, stopping serving of a content item), while the original event (or another copy of the event) is processed normally for other purposes (e.g., collection of statistics, regulatory compliance).

In optional operation 234, the batch server may further buffer or batch events (e.g., by batcher 332a of batch server 330a). In operation 236 an event (e.g., a low-priority event) is processed, by processer 334a for example, which may include recording the event along with pertinent data such as, but not limited to, identifiers of the corresponding content item and the user who received or interacted with the item, what caused the event, when it occurred, etc. Some or all of this information may be stored (e.g., in event database 126 of system 110 of FIG. 1). This information may also be obtained and stored for other types of events (e.g., events of type-1 and type-3) by the same or similar processer modules (not shown in FIG. 3). After operation 236, the method ends.

In operation 250, prioritized processing of a revenue or revenue-associated event (e.g., a type-1 event, a type-3 event) starts by identifying the advertisement, campaign, and/or account corresponding to the event. Some or all of this information may be received with the event. For example, the event notification may identify the specific ad (or other content item) that the event concerns, and the computer server handling the event may identify the ad's campaign and/or customer account by looking it up or by querying another system component.

In operation 252, the server that is handling the event (e.g., a budgeter module 322, 342) determines whether any budget associated with the ad is depleted. Illustratively, for each associated ad (at the ad, campaign, and/or account level), the server increments accrued charges for the current time period (and/or overall), including a cost or revenue associated with the current event, and determines whether a budget for a recurring time period (or an overall budget) has been expended. This operation may entail retrieving budgets and/or accrued expenses from a budget server if the information is not stored locally or otherwise available.

In operation 254, if any budget has been depleted, the system's content servers are immediately alerted (e.g., by a notifier 324, 344) so that they will stop serving the content associated with the depleted budget (e.g., one ad, a campaign of multiple ads, all ads of all campaigns for a given account). Other notifications may also be made, such as to a budget server, a recommendation engine (e.g., so that it will stop including the ad in its auctions), a statistics or analysis server that informs customers of the statuses of their accounts/campaigns/ads, etc.

In some embodiments, both fast-track server 320 and priority servers 340 may be considered priority servers. In particular, embodiments provided herein provide for prioritized handling and processing of revenue events (i.e., events that correspond to activity for which the content-serving system or its operator earns revenue). However, in some of these embodiments different types of revenue events may be processed at different servers or different collections of servers, as depicted in FIGS. 2 and 3, while in other embodiments all revenue events may be processed by one set of servers. Implementation of these embodiments may illustratively depend on how many revenue events are received in a given period of time, and how many events a given computer server can process in a unit of time.

In other embodiments, the operations of FIG. 2 may be ordered differently, a given operation may be divided into multiple operations, multiple operations may be merged, and/or a particular operation may be executed differently, without exceeding the scope of the invention.

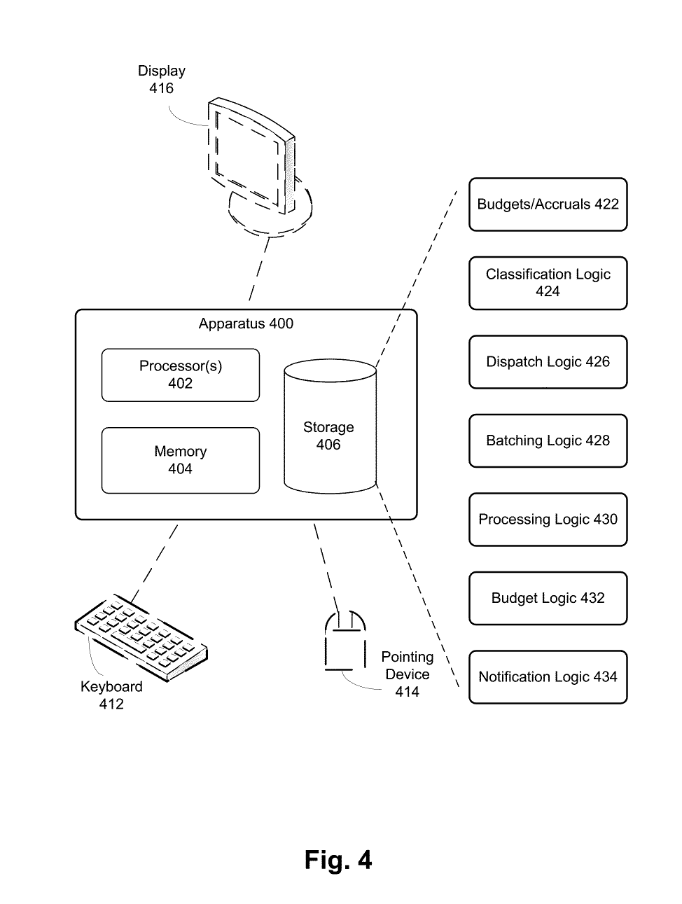

FIG. 4 depicts an apparatus for reducing or preventing over-delivery of sponsored content, according to some embodiments.

Apparatus 400 of FIG. 4 includes processor(s) 402, memory 404, and storage 406, which may comprise one or more optical, solid-state, and/or magnetic storage components. Storage 406 may be local or remote to the apparatus. Apparatus 400 may be coupled (permanently or temporarily) to keyboard 412, pointing device 414, and display 416. Multiple apparatuses 400 may cooperatively operate to handle and process events related to the serving of content from a content-serving system, or apparatus 400 may encompass multiple separate logical and/or physical components that operate similarly.

Storage 406 stores budget and/or accrual data 422, which identifies budgets associated with content served from the system, accrued expenses or charges for the budget, and/or remaining budgets (i.e., budgeted amounts not yet expended or earned), and facilitates rapid determination of whether a given budget has been exhausted.

Storage 406 also stores logic that may be loaded into memory 404 for execution by processor(s) 402. Such logic includes classification logic 424, dispatch logic 426, batching logic 428, processing logic 430, budget logic 432, and notification logic 434. In other embodiments, these logic modules may be combined or divided to aggregate or separate their functionality as desired.

Classification logic 424 comprises processor-executable instructions for classifying a received event (or an event for which a notification is received) into one of multiple types. In particular, logic 424 is executed to quickly identify some or all revenue events so that they may receive expedited processing, which will provide faster determination as to whether any budget associated with a corresponding sponsored event has been met.

Dispatch logic 426 comprises processor-executable instructions for dispatching or forwarding received events according to their priority or type, for processing by some other logic or apparatus. For example, dispatch logic 426 may send the highest-priority events (e.g., events of types that provide the greatest revenue) to one module or other apparatus (or a collection of modules/apparatuses), may send the next highest-priority events to a separate collection of modules/apparatuses, etc. In embodiments in which copies of priority events are made, so that one copy is processed normally and another copy is expedited to update the budget(s) of its corresponding content and allow serving of the content to be quickly shut off if a budget has been depleted, for example, the copies may be made by dispatch logic 426 or classification logic 424.

Batching logic 428 comprises processor-executable instructions for buffering multiple events, usually relatively low-priority events, before they are transmitted or forwarded en masse (e.g., by dispatch logic 426) for further processing.

Processing logic 430 comprises processor-executable instructions for processing individual events according to their priority and/or type. Thus, some or all events may be processed to record pertinent data (a corresponding content item/campaign/account, a member involved in the event, a time of the event), while prioritized events receive additional processing to determine whether any associated budget has been exhausted.

Budget logic 432 comprises processor-executable instructions for determining whether a budget has been exhausted. Logic 432 may therefore determine whether revenue earned from or due to a currently processed event, when combined with previous events for the same sponsored content item, campaign, and/or account, meet or exceed any of their budgets. A given budget may apply to a recurring time period (e.g., a day), or may cover all activity for an item, campaign, or account.

Notification logic 434 comprises processor-executable instructions for alerting other components of the content-serving system when a budget is depleted. An illustrative alert may cause a content server to stop serving one or more ads (e.g., a specific impression, a campaign encompassing multiple impressions), may cause a notification to be sent to a customer (e.g., an advertiser), and/or other action.

In some embodiments, apparatus 400 performs some or all of the functions ascribed to multiple components of system 110 of FIG. 1. Apparatus 400 may include other components, or function cooperatively with other components, to monitor depletion of sponsored content budgets and to help reduce or eliminate over-delivery of such content.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory, non-volatile memory, magnetic and optical storage devices such as disk drives, magnetic tape, CDs (compact discs) and DVDs (digital versatile discs or digital video discs), solid-state drives and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

1. A computer-implemented method, comprising:
receiving notifications of a plurality of events regarding states of a plurality of sponsored content items;
identifying a first event of the plurality of events as one of a first type, a second type, or a third type, wherein the first event is associated with a state of a first sponsored content item of the plurality of sponsored content items;
if the first event is of the first type that comprises a user interaction with the first sponsored content item:
forwarding the first event to a first computer; and
operating the first computer to:
determine whether a budget associated with the first sponsored content is depleted; and
if a budget associated with the first sponsored content item is depleted, cause the first sponsored content item to no longer be served during a period of time associated with the budget; and
if the first event is of the second type that comprises a serving of the first sponsored content item, batching the first event with multiple other events in the plurality of events prior to further processing the first event.

2. The method of claim 1, wherein forwarding the first event to the first computer comprises:
duplicating the first event; and
transmitting one copy of the first event to the first computer;
wherein the other copy of the first event is batched with the multiple other events in the plurality of events.

3. The method of claim 1, wherein forwarding the first event to the first computer comprises:
without batching the first event with any other events in the plurality of events, transmitting the first event to the first computer.

4. The method of claim 1, wherein:
the first type of event is a user interaction with a sponsored content item having a cost-per-click (CPC) budget or a cost-per-action (CPA) budget;
the second type of event is a serving of a sponsored content item having a cost-per-click (CPC) or a cost-per-action (CPA) budget; and
the third type of event is a serving of a sponsored content item having a cost-per-mille (CPM) budget.

5. The method of claim 4, further comprising:
if the first event is of the third type:
forwarding the first event to a second computer; and
operating the second computer to:
determine whether a budget associated with the first sponsored content item is depleted; and
if the budget is depleted, cause the first sponsored content item to no longer be served during a period of time associated with the budget.

6. The method of claim 5, wherein the second computer performs said determining and said causing for events of the third type, and not for events of the first type or the third type.

7. The method of claim 1, wherein the first computer performs said determining and said causing for events of the first type, and not for events of the second type or the third type.

8. The method of claim 1, wherein said batching comprises:
buffering the first event and the multiple other events; and
forwarding as a group the first event and the multiple other events to a set of computers for the further processing;
wherein the further processing of the multiple other events comprises determining whether any of multiple budgets associated with multiple other sponsored content items corresponding to the multiple other events have been depleted; and
wherein the set of computers does not include the first computer.

9. The method of claim 1, wherein:
said receiving, said identifying, said forwarding, and said batching are performed at a tracking computer different from the first computer.

10. The method of claim 1, wherein said determining comprises:
ascertaining whether a cost associated with obtaining the first event for the first sponsored content item, combined with costs associated with previous events during the period of time for the first sponsored content item, exceeds a periodic budget for the first sponsored content item during the period of time; and
ascertaining whether a cost associated with obtaining the first event for the first sponsored content item, combined with costs associated with previous events for the first sponsored content item, exceeds a maximum budget for the first sponsored content item.

11. The method of claim 10, wherein said determining further comprises:
ascertaining whether a cost associated with obtaining the first event for the first sponsored content item, combined with costs associated with previous events during the period of time for a campaign comprising the first sponsored content item, exceeds a campaign periodic budget for the campaign during period of time; and
ascertaining whether a cost associated with obtaining the first event for the first sponsored content item, combined with costs associated with previous events for the campaign, exceeds a maximum budget for the campaign.

12. The method of claim 11, wherein said determining further comprises:
ascertaining whether a cost associated with obtaining the first event for the first sponsored content item, combined with costs associated with previous events during the period of time for a customer corresponding to the campaign, exceeds a customer periodic budget for the customer during period of time; and
ascertaining whether a cost associated with obtaining the first event for the first sponsored content item, combined with costs associated with previous events for the customer, exceeds a maximum budget for the customer.

13. A system, comprising:
a tracking computer comprising a non-transitory computer-readable medium storing instructions that, when executed, cause the tracking computer to:
receive notifications of a plurality of events regarding states of a plurality of sponsored content items;
identify a first event of the plurality of events as one of a first type, a second type, or a third type, wherein the first event is associated with a state of a first sponsored content item of the plurality of sponsored content items; and
if the first event is of the first type that comprises a user interaction with the first sponsored content item, forward the first event to a first event-processing computer; and
the first event-processing computer comprising a non-transitory computer-readable medium storing instructions that, when executed, cause the first event-processing computer to:
determine whether a budget associated with the first sponsored content item is depleted; and
if a budget associated with the first sponsored content item is depleted, cause the first sponsored content item to no longer be served during a period of time associated with the budget;
wherein the non-transitory computer-readable medium of the tracking computer further stores instructions that, when executed, cause the tracking computer to, if the first event is of the second type that comprises a serving of the first sponsored content item, batch the first event with multiple other events in the plurality of events prior to further processing the first event.

14. The system of claim 13, wherein forwarding the first event to the first computer comprises:
duplicating the first event; and
transmitting one copy of the first event to the first computer;
wherein the other copy of the first event is batched with the multiple other events in the plurality of events.

15. The system of claim 13, wherein forwarding the first event to the first computer comprises:
without batching the first event with any other events in the plurality of events, transmitting the first event to the first computer.

16. The system of claim 13, wherein:
the first type of event is a user interaction with a sponsored content item having a cost-per-click (CPC) budget or a cost-per-action (CPA) budget;
the second type of event is a serving of a sponsored content item having a cost-per-click (CPC) or a cost-per-action (CPA) budget; and
the third type of event is a serving of a sponsored content item having a cost-per-mille (CPM) budget.

17. The system of claim 16, wherein:
the non-transitory computer-readable medium of the tracking module further stores instructions that, when executed, cause the tracking module to:
if the first event is of the third type, forward the first event to a second event-processing computer; and
the second event-processing computer comprises a non-transitory computer-readable medium storing instructions that, when executed, cause the second event-processing computer to:
determine whether a budget associated with the first sponsored content item is depleted; and
if a budget associated with the first sponsored content item is depleted, cause the first sponsored content item to no longer be served during a period of time associated with the budget.

18. The system of claim 13, wherein the first event-processing computer performs said determining and said causing for events of the first type, and not for events of the second type or the third type.

19. The system of claim 13, wherein said batching comprises:
buffering the first event and the multiple other events; and
forwarding as a group the first event and the multiple other events to a set of event-processing computers for the further processing;
wherein the further processing of the multiple other events comprises determining whether any of multiple budgets associated with multiple other sponsored content items corresponding to the multiple other events have been depleted; and
wherein the set of event-processing computers does not include the first computer.

20. The system of claim 13, wherein said determining comprises:
ascertaining whether a cost associated with obtaining the first event for the first sponsored content item, combined with costs associated with previous events during the period of time for the first sponsored content item, exceeds a periodic budget for the first sponsored content item during the period of time; and
ascertaining whether a cost associated with obtaining the first event for the first sponsored content item, combined with costs associated with previous events for the first sponsored content item, exceeds a maximum budget for the first sponsored content item.

21. The system of claim 20, wherein said determining further comprises:
ascertaining whether a cost associated with obtaining the first event for the first sponsored content item, combined with costs associated with previous events during the period of time for a campaign comprising the first sponsored content item, exceeds a campaign periodic budget for the campaign during period of time; and
ascertaining whether a cost associated with obtaining the first event for the first sponsored content item, combined with costs associated with previous events for the campaign, exceeds a maximum budget for the campaign.

22. The system of claim 21, wherein said determining further comprises:
ascertaining whether a cost associated with obtaining the first event for the first sponsored content item, combined with costs associated with previous events during the period of time for a customer corresponding to the campaign, exceeds a customer periodic budget for the customer during period of time; and
ascertaining whether a cost associated with obtaining the first event for the first sponsored content item, combined with costs associated with previous events for the customer, exceeds a maximum budget for the customer.

23. An apparatus, comprising:
a tracking module comprising a non-transitory computer-readable medium storing instructions that, when executed, cause the tracking module to:
receive notifications of a plurality of events regarding states of a plurality of sponsored content items;
identify a first event of the plurality of events as one of a first type, a second type, or a third type, wherein the first event is associated with a state of a first sponsored content item of the plurality of sponsored content items;
if the first event is of the first type that comprises a user interaction with the first sponsored content item, forward the first event to a first processing module; and
if the first event is of the second type that comprises a serving of the first sponsored content item:
batch the first event with multiple other events in the plurality of events regarding other sponsored content items; and
forward as a group the first event and the multiple other events to a set of processing modules that does not include the first processing module;
the first processing module comprising a non-transitory computer-readable medium storing instructions that, when executed, cause the first processing module to:
determine whether a budget associated with the first sponsored content item is depleted; and
if a budget associated with the first sponsored content item is depleted, cause the first sponsored content item to no longer be served during a period of time associated with the budget.
